(19) United States
(12) Patent Application Publication
(10) Pub. No.: US 2023/0187729 A1
(43) Pub. Date: Jun. 15, 2023

(54) MANUFACTURING METHOD FOR LITHIUM ION SECONDARY BATTERY

(71) Applicant: TOYOTA JIDOSHA KABUSHIKI KAISHA, Toyota-shi (JP)

(72) Inventor: Yuji YAMASHITA, Toyota-shi (JP)

(73) Assignee: TOYOTA JIDOSHA KABUSHIKI KAISHA, Toyota-shi (JP)

(21) Appl. No.: 17/992,068

(22) Filed: Nov. 22, 2022

(30) Foreign Application Priority Data
Dec. 9, 2021 (JP) 2021-199816

(51) Int. Cl. H01M 10/656; H01M 10/0525; H01M 50/46; H01M 10/44

(52) U.S. Cl. CPC H01M 10/656; H01M 10/0525; H01M 50/46; H01M 10/446

(57) ABSTRACT

A method of manufacturing a lithium ion secondary battery includes: manufacturing an electrode assembly including a positive electrode layer, a separator, and a negative electrode layer; encapsulating the electrode assembly and an electrolytic solution in an exterior body; assembling a battery cell; alternately laminating a bag-shaped member and the battery cell; and performing initial charging until an initial charging voltage is reached while constraining the battery cell at a constant pressure along a stacking direction of the battery cell, wherein the bag-shaped member is encapsulated with a fluid.

### CROSS-REFERENCE TO RELATED APPLICATION

This application claims priority to Japanese Patent Application No. 2021-199816 filed on Dec. 9, 2021, incorporated herein by reference in its entirety.

### BACKGROUND

### 1. Technical Field

The present disclosure relates to a manufacturing method for a lithium ion secondary battery.

### 2. Description of Related Art

A lithium ion secondary battery is widely used as a portable power source for a personal computer, a mobile terminal, and the like, and as a vehicle power source for a battery electric vehicle, a hybrid electric vehicle and the like. In particular, a lithium ion secondary battery is required to have a higher capacity as a vehicle power source.

In the lithium ion secondary battery, gas is generated by decomposition of a part of components of an electrolytic solution and additives and moisture contained in a battery member on the surface of an electrode during initial charging. Generation of the gas causes a failure in the battery characteristics. Therefore, as a method for degassing, for example, Japanese Unexamined Patent Application Publication No. 2013-125650 (JP 2013-125650 A) discloses that degassing is performed by applying a restraining pressure to the lithium ion secondary battery during initial charging. Further, JP 2013-125650 A discloses a method for further degassing by leaving the lithium ion secondary battery after the initial charging is completed.

In addition, when a restraining pressure is applied to the battery during initial charging, there is a possibility that an active material layer or the like in the electrode is damaged. Therefore, in order to suppress such damage, Japanese Unexamined Patent Application Publication No. 2020-107389 (JP 2020-107389 A) discloses a method for restraining the battery at a constant pressure using a spring-type restraining mechanism during initial charging, and restraining the battery to a fixed size using a restraining jig after the initial charging is completed.

### SUMMARY

However, there is room for improvement in uniformly applying the restraining pressure to the lithium ion secondary battery by the method disclosed in JP 2013-125650 A. In particular, for manufacturing a lithium ion secondary battery having a high capacity and a large electrode area, a large amount of gas is generated during initial charging. Therefore, it is difficult to uniformly apply the restraining pressure to the lithium ion secondary battery.

Further, there is also room for improvement in the method disclosed in JP 2020-107389 A. In particular, in the case of a battery having a large electrode area, variations in the restraining pressure applied at the center portion of the electrode and the end portion of the electrode occur. Therefore, there is a possibility that the battery characteristics are affected by breakage of an electrode layer or a solid electrolyte layer and occurrence of interruption of a lithium ion conduction path or an electron conduction path.

Therefore, an object of the present disclosure is to provide a manufacturing method for a lithium ion secondary battery capable of uniformly applying a restraining pressure to an electrode.

(1) A manufacturing method for a lithium ion secondary battery according to the present disclosure includes: fabricating an electrode assembly including a positive electrode layer, a separator, and a negative electrode layer; assembling a battery cell by enclosing the electrode assembly and an electrolytic solution in an exterior body; and stacking a bag-shaped member and the battery cell alternately and performing initial charging until a voltage reaches an initial charging voltage while restricting the battery cell at a constant pressure along a stacking direction of the battery cell. A fluid is enclosed in the bag-shaped member.

According to the manufacturing method of the above (1), the restraining pressure can be uniformly applied to the electrode.

That is, the bag-shaped member and the battery cell are alternately stacked. The fluid is enclosed in the bag-shaped member. The fluid can generate isotropic pressure. Therefore, when the battery cell is interposed between the bag-shaped members, the restraining pressure can be uniformly applied to the electrode of the battery cell.

(2) In the manufacturing method according to the above (1), a pressure control mechanism that controls a pressure of the bag-shaped member may be further provided.

(3) In the manufacturing method according to the above (1) or (2), a temperature adjustment mechanism that adjusts a temperature of the battery cell may be further provided.

(4) In the manufacturing method according to any one of the above (1) to (3), a fluid discharge mechanism that discharges the fluid in the bag-shaped member when a temperature of the battery cell exceeds a threshold temperature may be further provided.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic diagram illustrating an example of an electrode assembly of a lithium ion secondary battery according to an embodiment;

FIG. 2 is a schematic diagram illustrating a method of restraining a battery cell in the embodiment.

### DETAILED DESCRIPTION OF EMBODIMENTS

Hereinafter, an embodiment of the present disclosure will be described. However, the present disclosure is not limited thereto. In the present disclosure, the lithium ion secondary battery may be a liquid-based battery or an all-solid-state battery. Note that the lithium ion secondary battery is sometimes simply referred to as a “battery”.

### First Embodiment

### Method for Manufacturing Lithium Ion Secondary Battery

The method for manufacturing a lithium ion secondary battery according to the present embodiment includes “(A) preparation of an electrode assembly”, “(B) assembly of a battery cell”, and “(C) restraint and initial charging of a battery cell”.

### (A) Preparation of Electrode Assembly

The method of manufacturing the lithium ion secondary battery according to the present embodiment includes forming the electrode assembly 40 including the positive electrode layer 10, the separator 30, and the negative electrode layer 20.

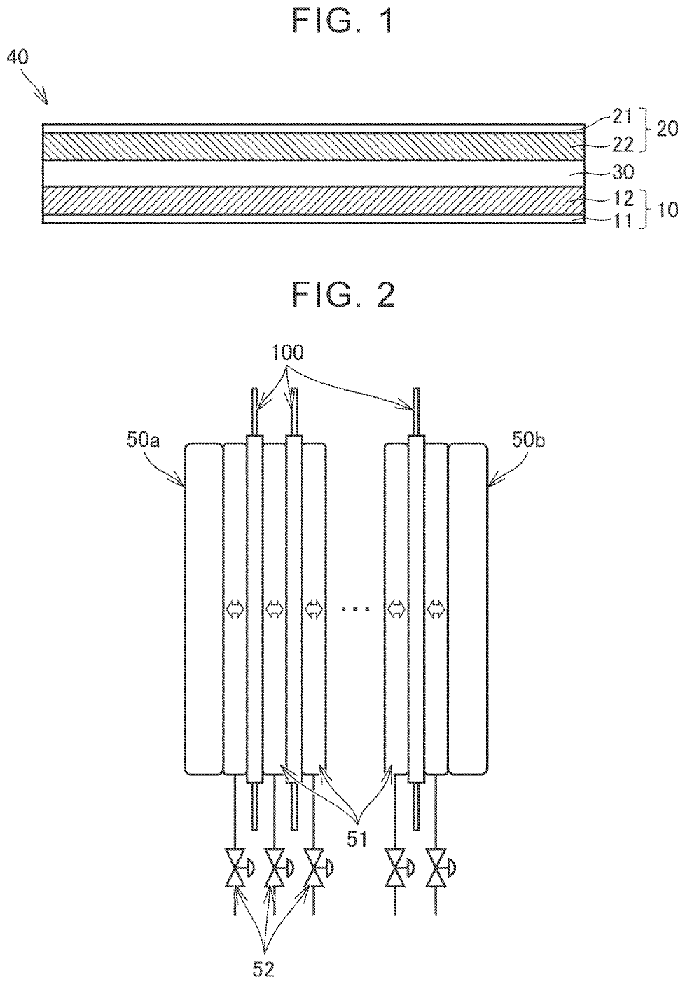

FIG. 1 is a schematic diagram illustrating an example of components of a lithium ion secondary battery according to the present embodiment. The electrode assembly 40 includes a positive electrode layer 10, a separator 30, and a negative electrode layer 20. The separator 30 separates the positive electrode layer 10 from the negative electrode layer 20. The positive electrode layer 10 is connected to a positive electrode terminal (not shown). The negative electrode layer 20 is connected to a negative electrode terminal (not shown).

The electrode assembly 40 is of a stacked type. The electrode assembly 40 may be of a wound type. The electrode assembly 40 is formed by laminating the positive electrode layer 10, the separator 30, and the negative electrode layer 20. The electrode assembly 40 may have an arbitrary laminated structure as long as the electrode assembly 40 includes one or more positive electrode layers 10, a separator 30, and a negative electrode layer 20. For example, the electrode assembly 40 may be formed by laminating the positive electrode layer 10, the separator 30, the negative electrode layer 20, the separator 30, and the positive electrode layer 10 in this order.

The positive electrode layer 10 is in close contact with the separator 30. The positive electrode layer 10 includes a positive electrode collector foil 11 and a positive electrode mixture layer 12. The positive electrode collector foil 11 may be, for example, an aluminum (Al) foil.

The positive electrode mixture layer 12 includes at least a positive electrode active material. The positive electrode mixture layer 12 may be made of, for example, a substantially positive electrode active material. The positive electrode mixture layer 12 may include, for example, a conductive material, a binder, and the like in addition to the positive electrode active material. The positive electrode active material, for example, lithium cobaltate, lithium nickelate, lithium manganate, lithium nickel cobalt manganate or the like (e.g., L_{1.15}N_{1/3}Co_{1/3}Mn_{1/3}O₂ etc.), lithium nickel cobalt aluminate, and lithium iron phosphate may include at least one selected from the group consisting of lithium iron phosphate. The positive electrode active material may be subjected to surface treatment. A buffer layer may be formed on the surface of the positive electrode active material by surface treatment. The buffer layers may comprise, for example, lithium niobate (LiNbO₃) or the like. The conductive material may include, for example, a conductive carbon material [e.g., vapor grown carbon fiber (VGCF)] or the like. The binder may include, for example, polyvinylidene fluoride (PVdF).

The separator 30 is interposed between the positive electrode layer 10 and the negative electrode layer 20. The separator 30 spatially separates the positive electrode layer 10 and the negative electrode layer 20. The separator 30 blocks electron conduction between the positive electrode layer 10 and the negative electrode layer 20. When the battery in the present embodiment is a liquid-based battery, the separator 30 is porous. The porous portion of the separator 30 is impregnated with an electrolytic solution having lithium ion conductivity. When the battery in the present embodiment is an all-solid-state battery, the solid electrolyte layer having lithium ion conductivity serves as the separator 30. The separator 30 may be made of polyolefin, for example. The separator 30 may have, for example, a single-layer structure. The separator 30 may be made of, for example, a polyethylene (PE) layer. The separator 30 may have, for example, a multilayer structure. The separator 30 may have, for example, a three-layer structure. The separator 30 may include, for example, a polypropylene (PP) layer, a PE layer, and a PP layer. The PP layer, the PE layer, and the PP layer may be laminated in this order.

The negative electrode layer 20 is in close contact with the separator 30. The negative electrode layer 20 includes a negative electrode collector foil 21 and a negative electrode mixture layer 22. The negative electrode collector foil 21 may be, for example, a copper (Cu) foil, a nickel (Ni) foil, or the like.

The negative electrode mixture layer 22 includes at least a negative electrode active material. The negative electrode mixture layer 22 may be made of, for example, a substantially negative electrode active material. The negative electrode mixture layer 22 may include, for example, a conductive material, a binder, and the like in addition to the negative electrode active material. The negative electrode active material may include, for example, at least one selected from the group consisting of graphite, soft carbon, hard carbon, silicon, silicon oxide, silicon-based alloys, tin oxide, tin-based alloys, and lithium titanate (Li₄Ti₅O₁₂).

### (B) Battery Cell Assembly

A method of manufacturing a lithium ion secondary battery according to the present embodiment includes encapsulating an electrode assembly and an electrolytic solution in an exterior body, and assembling a battery cell.

The exterior body may have any form. The exterior body may be, for example, a metal container or the like. The exterior body may be, for example, pouches made of aluminum lamination film. The exterior body may be, for example, a square shape or a cylindrical shape. The exterior body may have, for example, an inlet for injecting an electrolytic solution.

The electrolytic solution includes a supporting electrolyte and an organic solvent. The electrolytic solution is injected into the exterior body. The electrode assembly is impregnated with an electrolytic solution. After the injection of the electrolytic solution, the exterior body is sealed. As described above, the battery cell is assembled.

### (C) Battery Cell Restraint and Initial Charge

The method of manufacturing a lithium ion secondary battery according to the present embodiment includes alternately stacking a bag-shaped member and a battery cell, and performing initial charging until the initial charging voltage is reached while restraining the battery cell at a constant pressure along the stacking direction of the battery cells. The bag-shaped member has a fluid enclosed therein.

FIG. 2 is a schematic diagram illustrating a method of restricting a battery cell at a constant pressure in the present embodiment. Hereinafter, a method of restricting the constant pressure of the battery cell 100 by the method is shown, but a method of restricting the constant pressure of the battery cell 100 shown below is merely an example.

As shown in FIG. 2, in this method, a plurality of battery cells 100 and a plurality of bag-shaped members 51 are alternately stacked, and a plurality of battery cells 100 and a plurality of bag-shaped members 51 are disposed between a pair of end plates 50a and 50b that face each other while being sandwiched in the stacking direction of the battery cells 100. That is, each battery cell 100 is sandwiched between a pair of end plates 50a and 50b. The battery cells 100 are disposed adjacent to each other via the bag-shaped member 51. Each of the battery cells 100 is arranged such that a constrained pressure is applied in the stacking direction of the positive electrode layer 10, the separator 30, and the negative electrode layer 20. When the end plate 50 and the battery cell 100 are in direct contact with each other, the exterior body may be damaged or damaged. Therefore, it is preferable that the bag-shaped member 51 is disposed between the end plate 50 and the battery cell 100.

After the arrangement as described above, the restraining pressure is applied to the battery cell 100 by the pressure of the fluid enclosed in the bag-shaped member 51. Accordingly, the battery cell 100 is restrained.

The pressure applied to the battery cell is not particularly limited. When the applied pressure is small, there is a possibility that the restraining pressure cannot be uniformly applied to the battery cell 100. When the applied pressure is large, the battery cell may be deformed or the bag-shaped member may be damaged. For this reason, the applied pressure may be appropriately adjusted in a range of, for example, 10 kPa or more and 50 kPa or less.

Here, the difference between the constant pressure constraint in the present embodiment and the conventional constant pressure constraint will be described. As also disclosed in JP 2020-107389 A, conventionally, constant pressure restraint is generally performed using a spring-type restraint mechanism. However, with the spring-type restraint mechanism, when the battery cell expands and contracts during initial charging, the spring is displaced considerably. That is, the spring expands and contracts due to expansion and contraction of the battery cell itself. Therefore, constant pressure constraint can be realized in a certain pressure range. However, a constant pressure was not necessarily maintained. In addition, as the battery cells expand and contract, the terminals that perform charging and discharging are inevitably moved in the restraining axis direction, and it is necessary to install a mechanism that follows the movement of the terminals in the charging and discharging equipment.

On the other hand, in the constant pressure restraint in the present embodiment, a bag-shaped member in which a fluid is enclosed is used. Since the fluid can generate isotropic pressure, pressure can be applied uniformly to the battery cells. Further, in the bag-shaped member, even if the battery cell expands and contracts during initial charging, the bag-shaped member absorbs a change in the thickness of the battery cell. Thus, a constant pressure constraint can be achieved. Further, since there is no movement of the terminal during charging and discharging as described above, it is not necessary to install a mechanism following the movement of the terminal in the charging and discharging facility.

### Bag-Shaped Member

The bag-shaped member is made of a material capable of applying a constant pressure to the battery cell without breaking even if the battery cell is restrained. The specific material of the bag-shaped member may be appropriately selected. When the restraining pressure is low, examples of the material include a plastic sheet such as polypropylene that is composited with paper and formed into a bag shape. When the restraining pressure is moderate, examples of the material include a nylon fabric represented by an airbag of an automobile or a polyester fabric coated with a silicone resin. When the constraining pressure is high, examples of the material include neoprene rubber reinforced with high-strength fibers such as aramid.

The fluid may be a gas or a liquid. Examples of the gas include air, and examples of the liquid include water.

### End Plate

The pair of end plates face each other with the bag-shaped member and the battery cell sandwiched therebetween in the stacking direction of the battery cells. The shape of the end plate may be any shape.

The material of the end plate may be any material having a strength that does not break when constrained to a constant pressure. Examples thereof include metals such as iron, SUS (stainless steel), and aluminum alloys, and fiber-reinforced plastics such as carbon fiber-reinforced plastics and glass fiber-reinforced plastics. Initial charge

The initial charging may be performed at a normal temperature (about 25° C.±5° C.). Although the initial charging voltage varies depending on the electrolytic solution or the like to be used, the initial charging voltage may be, for example, 1V or more and 5V or less, 1.5V or more and 4.5V or less, or 2V or more and 4V or less.

Further, the initial-charge voltage may be adjusted by constant-charge (CC-charge), and may be, for example, about 0.1 C or more and 10 C or less, about 0.1 C or more and SC or less, or about 0.1 C or more ore 2 C or less. Alternatively, the initial charging may be performed at a constant current until a predetermined voltage is reached from the start of charging, and may be performed by constant current-constant voltage charging (CC-CV charging) in which charging is performed at a constant voltage for a predetermined period of time.

### Pressure Control Mechanism

In the present embodiment, a pressure control mechanism for controlling the pressure of the bag-shaped member may be provided. As the pressure control mechanism, for example, as shown in FIG. 2, a pressure control valve 52 or the like is exemplified. The pressure of each bag-shaped member may be individually controlled by a pressure control valve 52 connected to each bag-shaped member, or may be collectively controlled by one pressure control valve 52.

### Experiment 1

In Experiment 1, the effects of Embodiment 1 are described.

An electrode assembly in which a positive electrode, a separator, and a negative electrode were laminated was housed in an exterior body made of a laminate film. After the electrolytic solution was injected, the exterior body was sealed, and a battery cell of the lithium ion secondary battery was assembled. In addition, a bag-shaped member in which compressed air was enclosed was prepared.

Referring to FIG. 2, five battery cells 100 and six bag-shaped members 51 were alternately stacked so that a restraining pressure was applied in the stacking direction of the stacked electrode assemblies between the pair of end plates 50a and 50b. A pressure control valve 52 is connected to each bag-shaped member 51, and the pressure control valve 52 is controlled to have a constant pressure.

The pressure of the compressed air in the bag-shaped member 51 exerts a constrained pressure on the battery cell 100, and the battery cell 100 is constrained to a constant pressure, and initial charging is performed until the initial charging voltage is reached.

With the above-described configuration, it is possible to uniformly apply the restraining pressure to the electrodes of the battery cells 100. In addition, the bag-shaped member was able to absorb a change in the thickness of the battery cell in response to expansion and contraction of the battery cell 100 caused by the initial charging.

### Second Embodiment

The second embodiment is different from the first embodiment in that a temperature adjustment mechanism for adjusting the temperature of the battery cell is further provided.

For example, in a case where a battery characteristic in which a temperature factor is eliminated is obtained by making the temperature of the battery cell as uniform as possible, the influence of heat generation of the battery cell due to charging and discharging can be eliminated by cooling the battery cell with the fluid enclosed in the bag-shaped member.

Examples of the temperature adjustment mechanism include a chiller (coolant circulation device) and the like.

Further, a charge/discharge stopping mechanism may be provided which monitors the temperature of the fluid enclosed in the bag-shaped member and stops charging and discharging when the temperature of the fluid exceeds the threshold temperature.

For example, there is a possibility that the battery cell is short-circuited due to foreign matter or the like during initial charging, and when the battery cell generates heat due to a short-circuit, the temperature of the fluid rises. Thus, by monitoring the temperature of the fluid, a short circuit of the battery cell can be foreseen. Further, by providing a charge/discharge stop mechanism for stopping charge/discharge, when the temperature of the fluid exceeds the threshold temperature, heat generation of the battery cell can be suppressed.

### Experiment 2

In Experiment 2, the effects of Embodiment 2 are described.

The configuration was the same as that of Experiment 1 except that coolant was enclosed in the bag-shaped member instead of compressed air, and the chiller was connected to the bag-shaped member as a temperature adjustment mechanism.

With the above-described configuration, in addition to obtaining the same effect as in Experiment 1, variations in temperature between battery cells due to cooling of the battery cells with coolant are reduced. Thus, stable initial charging can be performed.

### Embodiment 3

In the third embodiment, a fluid discharge mechanism is further provided for discharging the fluid inside the bag-shaped member when the temperature of the battery cell exceeds the threshold temperature. In this respect, Embodiment 3 is different from Embodiments 1 and 2.

For example, there is a possibility that the battery cell is short-circuited due to foreign matter or the like during initial charging. In particular, when a high-capacity battery cell is initially charged, the amount of heat generated by the battery cell may increase. Therefore, by providing the fluid discharge mechanism that discharges the fluid inside the electric bag-shaped member, it is possible to suppress the battery cell from generating heat when the temperature of the pond cell exceeds the threshold temperature.

Examples of the fluid discharge mechanism include installing a valve on a bag-shaped member.

### Experiment 3

In Experiment 3, the effects of Embodiment 3 are described.

The configuration was the same as in Experiment 2 except that the valve was installed in the bag-shaped member as the fluid discharge mechanism.

With the above-described configuration, in addition to the same effects as those of Experiments 1 and 2, when a temperature abnormality occurs in the battery cell, the valve of the bag-shaped member is opened, and the battery cell is cooled by the coolant. As a result, heat generation of the battery cell is suppressed, and initial charging can be efficiently performed.

The presently disclosed embodiments and examples are to be considered in all respects as illustrative and not restrictive. It is intended that the scope of the disclosure be defined by the appended claims rather than the foregoing description, and that all changes within the meaning and range of equivalency of the claims be embraced therein.

What is claimed is:

1. A manufacturing method for a lithium ion secondary battery comprising:
fabricating an electrode assembly including a positive electrode layer, a separator, and a negative electrode layer;
assembling a battery cell by enclosing the electrode assembly and an electrolytic solution in an exterior body; and
stacking a bag-shaped member and the battery cell alternately and performing initial charging until a voltage reaches an initial charging voltage while restricting the battery cell at a constant pressure along a stacking direction of the battery cell, wherein a fluid is enclosed in the bag-shaped member.

2. The manufacturing method according to claim 1, wherein a pressure control mechanism that controls a pressure of the bag-shaped member is further provided.

3. The manufacturing method according to claim 1, wherein a temperature adjustment mechanism that adjusts a temperature of the battery cell is further provided.

4. The manufacturing method according to claim 1, wherein a fluid discharge mechanism that discharges the fluid in the bag-shaped member when a temperature of the battery cell exceeds a threshold temperature is further provided.
